(19) United States
(12) Patent Application Publication
(10) Pub. No.: US 2014/0012999 A1
(43) Pub. Date: Jan. 9, 2014

(54) METHOD OF ESTABLISHING PAID CONNECTION USING SCREEN MIRRORING APPLICATION BETWEEN MULTI- PLATFORMS

(71) Applicant: Awind Inc., New Taipei City (TW)

(72) Inventors: Kuo-Lung CHANG, New Taipei City (TW); Hsing-Yung WANG, New Taipei City (TW); Meng-Chung HUNG, New Taipei City (TW); Kuan-Yu CHOU, New Taipei City (TW); Chin-Jung FAN, New Taipei City (TW); Shih-Pin LIU, New Taipei City (TW); Li-Ger CHEN, New Taipei City (TW)

(73) Assignee: Awind Inc., New Taipei City (TW)

(21) Appl. No.: 14/022,221

(22) Filed: Sep. 10, 2013

Related U.S. Application Data
(63) Continuation-in-part of application No. 13/217,217, filed on Aug. 24, 2011, now Pat. No. 8,560,704.

(51) Int. Cl. H04L 12/14

(52) U.S. Cl. CPC H04L 12/1407
USPC 709/228

(57) ABSTRACT

A method of establishing a paid connection using a screen mirroring application between multi-platforms is disclosed. A transmitting end application is installed in a transmitting end apparatus of a sharing source. A receiving end application is installed in a receiving end apparatus of a sharing target. If the transmitting end application is a paid version, an unlimited connection is established for performing screen mirroring between the transmitting end apparatus and any receiving end apparatus. If the transmitting end application is a free version, the method further confirms if the receiving end application is a paid version for deciding whether a limited connection or an unlimited connection should be established. Thus, it is assured that either the transmitting end application or the receiving end application is a paid version, the interests of application developers are protected and users are free from paying twice for establishing one connection.

### CROSS REFERENCES RELATED TO THE APPLICATION

This application is a continuation-in-part application of U.S. patent application Ser. No. 13/217, 217 filed on Aug. 24, 2011.

### BACKGROUND OF THE INVENTION

1. Field of the Invention

The present invention relates to a method for establishing a connection between multi-platforms, in particular, the present invention relates to a method of establishing a paid connection between multi-platforms.

2. Description of Related Art

In recent years, electronic industries grow rapidly and various electronic devices are widely used in everyday life. Users use electronic devices for entertaining purposes, such as displaying films and executing games. In addition, work efficiency is significantly improved with the convenient functions delivered by electronic devices.

The functions provided by electronic devices rely on the capabilities of hardware and associated software. For example, users play movies with film playing application on computers. In general, users purchase paid application or download free application depending on the marketing strategies of application developers. Nonetheless, when application is executed on a plurality of electronic devices, the charging mechanism is required to redesign by the application developer.

In an example of screen mirroring application, a screen mirroring application transmits multimedia data displayed on the screen of a first electronic device to the screen of a second electronic device via network systems. Under the circumstance, it is required to install a transmitting end screen mirroring application (referred in the following as transmitting end application) on the first electronic device for transmitting data, and it is required to install a receiving end screen mirroring application (referred in the following as receiving end application) on the second electronic device for receiving and processing data.

In view of application developers, when the above transmitting end applications and receiving end applications are free to download by users, it is convenient to use but difficult to collect charges. Accordingly, the interests of application developers are at risk. Further, when a transmitting end application and a receiving end application are both paid, even if the pricing of these applications can be changed if required, yet users have to perform the paying procedures twice, which is inconvenient to the users. Thus, it is an option to charge either a transmitting end application or a receiving end application when performing the function via a network connection. In order to provide the above screen mirroring function to users, display devices in the markets (for example, a smart television, a projector, and a expanded device for supporting screen mirroring), receiving end applications or transmitting end applications provided by application developers are installed in the devices by default in the factories. Thus, users are allowed to browse the display devices connected to a network and perform screen mirroring with corresponding screen mirroring applications after purchasing the above display devices. However, it is a bottleneck to overcome by application developers to work out on royalty collection mechanisms with manufacturers of display devices.

Part of the manufacturers are not willing to increase the manufacturing cost of display devices for installing free screen mirroring applications, and users are required to purchase and install paid screen mirroring applications in a display device for performing screen projection. Part of the manufacturers are willing to pay reasonable costs and install paid screen mirroring applications in a display device such that users are allowed to establish a connection with display devices via installing free screen mirroring applications in the electronic device. However, there are concerns to application developers to resolve such as the reasonable royalties of the applications and the range of authorized functions to the screen mirroring applications installed (for example, which platforms are supported by screen mirroring applications or which document content is supported by the screen mirroring applications). For example, when a display device is installed with a free screen mirroring application, users have to use a paid screen mirroring application for establishing a connection. Otherwise, application developers cannot collect any charges. When a display device is installed with a paid screen mirroring application, the users are allowed to use a free screen mirroring application for establishing a connection. In addition, when a display device is installed with a paid screen mirroring application and users use a free screen mirroring application for establishing a connection, it is required to judge if the screen mirroring application supports the system platforms used by the screen mirroring source, or supports the document content of the screen projection.

### SUMMARY OF THE INVENTION

It is an objective of the present invention to provide a method of establishing a paid connection using a screen mirroring application between multi-platforms. The method is used to assure that either of the transmitting end application and the receiving end application is a paid version. Thus, the interests of application developers are protected. In order to achieve the above objective, a transmitting end apparatus of a sharing source is installed with a transmitting end application, and a receiving end apparatus of a sharing target is installed with a receiving end application according to the present invention. When the transmitting end application is a paid version, the transmitting end apparatus establishes an unlimited connection with any receiving end apparatus for performing screen mirroring. If the transmitting end application is a free version, it is required to further confirm if the receiving end application is a paid version in order to decide whether the connection to establish between the transmitting end apparatus and the receiving end apparatus is a limited connection or an unlimited connection.

The other objective of the present invention is to provide a method of establishing a paid connection using a screen mirroring application between multi-platforms. When a screen mirroring application is installed in a receiving end apparatus by the third party, the screen mirroring application can be configured to decide which platforms are supported based on the amount of payment made to the application developer by a third party company. The purpose of the method is to provide a cooperation model between an application developer and third party.

In order to achieve the above objective, a transmitting end apparatus of a sharing source is installed with a transmitting end application, and a receiving end apparatus of a sharing target is installed with a receiving end application according to the present invention. If the transmitting end application is a free version, and the receiving end application is a paid version, it is required to further confirm if the paid receiving end application supports the platform used by the free transmitting end application in order to decide whether the connection to establish between the transmitting end apparatus and the receiving end apparatus is a limited connection or an unlimited connection.

A screen mirroring application is used for transmitting the screen data of a transmitting end apparatus (for example a mobile phone) to a receiving end apparatus (for example a smart television), and the screen data of a transmitting end apparatus is displayed on the screen of the receiving end apparatus for performing the function similar to screen mirroring via a network system. In contrast with the related art, the advantage of the present invention is that a paid transmitting end application is useful in implementing screen mirroring of a transmitting end apparatus to any receiving end apparatus, users do not need to purchase a paid receiving end application and user interests are protected. On the other hand, if a paid receiving end application is installed in a receiving end apparatus, then the paid receiving end application is used for assisting with receiving the screen image data transmitted from the transmitting end apparatus. Thus, users are not required to purchase a paid transmitting end application.

Further, if a transmitting end apparatus of a sharing source is installed with a free transmitting end application, and a receiving end apparatus of a sharing target is installed with a free receiving end application, users are allowed to establish a limited connection. Thus, it is assured that either of the apparatus is installed with a paid version application and the interests of application developers are protected.

Moreover, based on the pricing of screen mirroring applications, the screen mirroring applications can be configured to support designated screen mirroring operations of designated system platforms. Also, according to the properties of screen mirroring applications, the screen mirroring applications can be configured to support transferring designated document content which is to share and support receiving designated document content which is shared.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a first is a system block diagram of a preferred embodiment of the present invention;

FIG. 2 is a system architecture diagram of a preferred embodiment of the present invention;

FIG. 3A is a first flow chart of a preferred embodiment according to the present invention; FIG. 3B is a second flow chart of a preferred embodiment according to the present invention.

FIG. 4A is a first flow chart of another preferred embodiment according to the present invention;

FIG. 4B is a second flow chart of another preferred embodiment according to the present invention;

FIG. 5 is a third flow chart of a preferred embodiment according to the present invention

FIG. 6 is a first flow chart of still another preferred embodiment according to the present invention; and

FIG. 7 is a first flow chart of the other preferred embodiment according to the present invention.

### DETAILED DESCRIPTION OF THE INVENTION

In cooperation with attached drawings, the technical contents and detailed description of the present invention are described thereinafter according to preferred embodiments, being not used to limit its executing scope. Any equivalent variation and modification made according to appended claims is all covered by the claims claimed by the present invention.

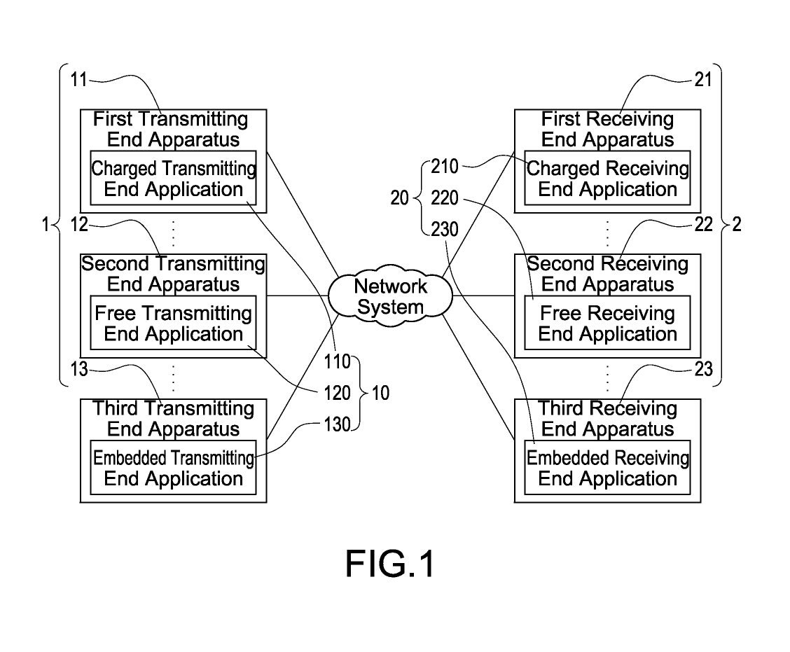

FIG. 1 is a first is a system block diagram of a preferred embodiment of the present invention. According to the present invention, the method of establishing a paid connection using a screen mirroring application between multi-platforms is used between at least a transmitting end apparatus 1 and at least a receiving end apparatus 2. The transmitting end apparatus 1 and the receiving end apparatus 2 are both installed with a screen mirroring application. The screen mirroring applications are used for perform screen mirroring of the transmitting end apparatus 1 on the screen of the receiving end apparatus 2 via network systems to display. The differences of the screen mirroring applications are that the transmitting end apparatus 1 is installed with a transmitting end application 10, and the receiving end apparatus 2 is installed a receiving end application 20.

As shown of FIG. 1, the transmitting end application 10 can be a paid transmitting end application 110 or a free transmitting end application 120. Users purchase from an application developer and install the paid transmitting end application 110 in a first transmitting end apparatus 11. Further, users may download and install the free transmitting end application 120, in a second transmitting end apparatus 12.

The receiving end application 20 can be a paid receiving end application 210 and a free receiving end application 220. Users purchase from an application developer and install the paid receiving end application 210 in a first receiving end apparatus 21. Further, users download and install the free receiving end application 220 in a second receiving end apparatus 22. It should be noted that, the receiving end apparatus 2 usually has a display screen larger than the screen of the transmitting end apparatus 1, for example, a smart television or large screen notebook computer. In addition, the receiving end application 20 can be an embedded receiving end application 230. The receiving end apparatus 2, for example, a third receiving end apparatus 23 is installed with an embedded receiving end application 230 by default in factories. Thus, users do not need to purchase and install the receiving end application separately which is more convenient to users.

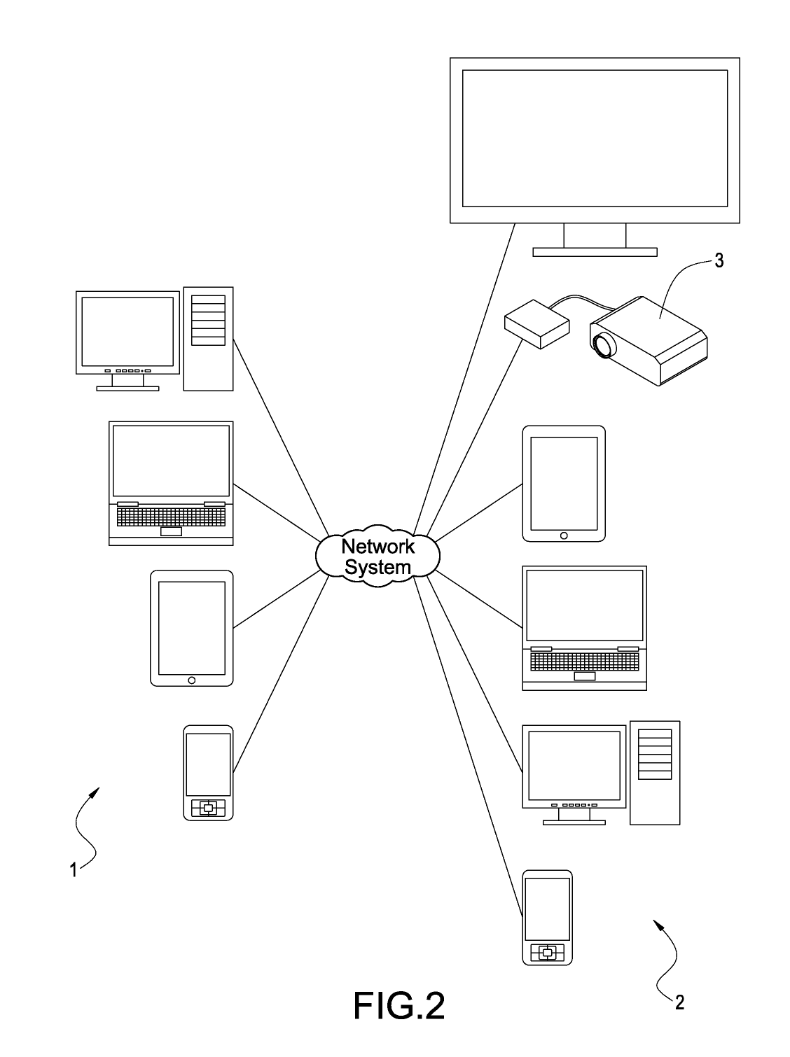

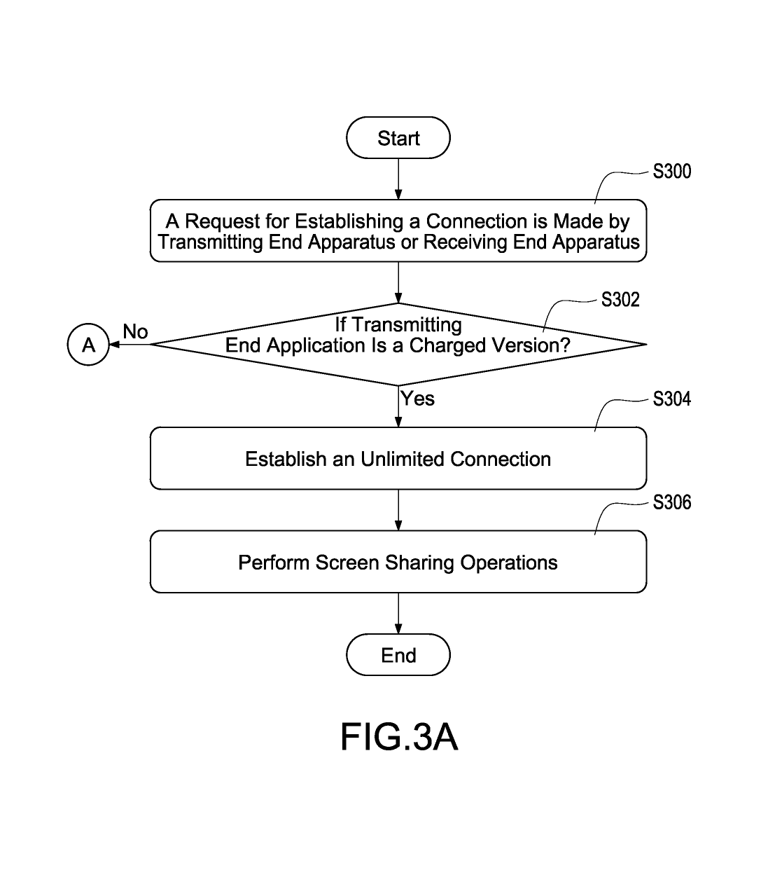

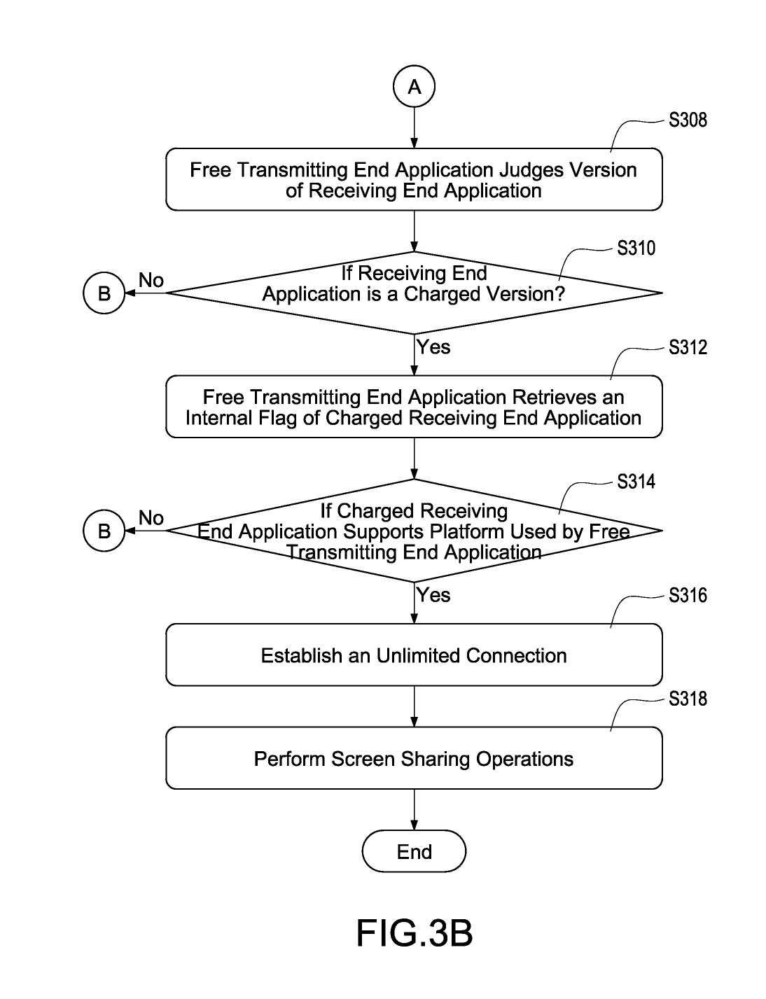

However, in another embodiment, the size of the display screen on the receiving end apparatus 2 may be smaller than the size of the display screen on the transmitting end apparatus 1. For example, the transmitting end apparatus 1 is a smart TV. As the example shown in FIG. 3, the third transmitting end apparatus 13 is installed with an embedded transmitting end application 130 by default in factories. The receiving end apparatus 2 is a smart phone or a tablet. The smart TV transmits the content of television shows to the smart phone or the tablet to display via the connection and sharing function established between the transmitting end application 10 and the receiving end application 20. Thus it is made convenient to users to watch television shows anywhere. FIG. 2 is a system architecture diagram of a preferred embodiment of the present invention. In general, the transmitting end apparatus 1 can be a Personal Computer (PC), a Notebook Computer, a Tablet, a Smart Phone, and a Smart TV etc. and are not limited thereto. The transmitting end apparatus 1 uses an internal controller for executing multimedia files, for example, playing movies or executing games, opening a document (for example an Office document or a PDF document) or other applications (for example activating camera lens), and transmitting the screen of the transmitting end apparatus 1 via the screen mirroring application installed.

The receiving end apparatus 2 can be a Smart Computing Device, Personal Computer (PC), a Notebook Computer, a Tablet, and a Smart Phone etc. The screen mirroring application is installed for receiving the data transmitted by the transmitting end apparatus 1. The transmitted data is decompressed, decoded and displayed on the screen. It should be noted that if users transmits the screen of the transmitting end apparatus 1 to an apparatus which is not capable of executing application automatically, for example, a projector 3. The receiving end apparatus 2 further can be a expanded device which is electrically coupled to the projector 3. The receiving end application 20 is installed and executed in the expanded device, and the expanded device receives data from the transmitting end apparatus 1. The received data is decompressed and decoded. The images and sounds generated by the data decompression and decoding are transmitted to the projector 3 for performing screen mirroring.

The advantages of the present invention are that if a screen mirroring application installed in the transmitting end apparatus 1 is a paid version, i.e. the paid transmitting end application 110, the transmitting end apparatus 1 establishes an unlimited connection with the receiving end apparatus 2 using any platform and performs screen mirroring. For example, the first transmitting end apparatus 11 in FIG. 1 establishes an unlimited connection with the first receiving end apparatus 21, the second receiving end apparatus 22, and the third receiving end apparatus 23. Similarly, if the screen mirroring application installed in the receiving end apparatus 2 is a paid version, then the receiving end apparatus 2 is allowed to establish an unlimited connection with a transmitting end apparatus 1 in any platforms and perform screen mirroring operations. For example, the receiving end apparatus 21 in the FIG. 1 is allowed to freely establish a connection with the first transmitting end apparatus 11 or the second transmitting end apparatus 12 for receiving and display the screen image of the transmitting end apparatuses 11 and 12. If the screen mirroring application installed in the transmitting end apparatus 1 is a free version, i.e., the free transmitting end application 120, the free transmitting end application 120 has to determine the version the receiving end application 20 of the sharing target before a connection is established. If the receiving end apparatus 2 of the sharing target is installed with the free receiving end application 220, a limited connection is established between the transmitting end apparatus 1 and the receiving end apparatus 2 (detailed in the following). On the other hand, if the receiving end apparatus 2 of the sharing target is installed with the paid receiving end application 210, an unlimited connection is established between the transmitting end apparatus 1 and the receiving end apparatus 2. In addition, screen mirroring is performed after the connection is successfully connected.

The above determining mechanism can be executed by the receiving end application 20. For example, if the screen mirroring application installed in the receiving end apparatus 2 is a free receiving end application 220, then the free receiving end application 220 first judges the version of the transmitting end application 10 of the sharing source when the transmitting end apparatus 1 requests to make a connection. If the transmitting end apparatus 1 of the sharing source is installed with the free transmitting end application 120, then the receiving end apparatus 2 and the transmitting end apparatus 1 can only establish a limited connection. On the other hand, if the transmitting end apparatus 1 of the sharing source is installed with the paid transmitting end application 110, then the receiving end apparatus 2 and the transmitting end apparatus 1 can establish an unlimited connection and perform screen mirroring operations after the connection is established successfully.

In other words, when the transmitting end apparatus 1 and the receiving end apparatus 2 establish a connection, the transmitting end application 10 in the transmitting end apparatus 1 can be used for determining which types of connections are allowed to establish (limited or unlimited); also, the receiving end application 20 in the receiving end apparatus 1 can be used for determining which types of connections are allowed to establish, and are not limited thereto. Among which, if the application used for determining is a paid version (for example a paid transmitting end application 110 or a paid receiving end application 210), then the application is allowed to establish an unlimited connection without the determining mechanism. It should be noted that an application developer decides which platforms used by the transmitting end application 10 (or the receiving end application 20) are supported by the paid receiving end application 210 (or the paid transmitting end application 110) depending on the pricing of the paid receiving end application 210 (or the paid transmitting end application 110). As shown in Table A, a supporting schematic diagram of the transmitting end application 10/the receiving end application 20 is illustrated.

TABLE A

| paid receiving | | | |
|---|---|---|---|
| end application/ | | | |
| paid | free transmitting end application/ | | |
| transmitting end | free receiving end application | | |
| application | not supporting | supporting | Pricing |
| A | | Windows only | 0.99 |
| B | android/iOS/BB | Windows/Mac | 1.99 |
| C | android/Windows/BB | Mac/iOS | 1.99 |
| D | None | ALL | 3.99 |
| E | All | None | Free |

In the example of using an paid receiving end application 210, if the price of the paid receiving end application 210 is lower, for example, the retail price of an A application is USD$0.99 in Table A, an application developer configures the internal flag of the paid receiving end application 210 according to low retail price of the A application for defining that the A application only supports the windows platform used by the free transmitting end application 120. When the free transmitting end application 120 using a Mac platform establishes a connection with the A application, the free transmitting end application 120 has to confirm that the A application is a paid version, the free transmitting end application 120 further judges if the A application supports the Mac platform. As shown in Table A, the free transmitting end application 120 using the Mac platform cannot establish an unlimited connection with the A application. However, Table A is a preferred embodiment of the present invention and the scope of the invention is not limited thereto.

As the B application and the C application shown in Table A, when the retail price is higher, the application developer configures that the B application and the C application support more platforms. Take examples shown in Table A, the B application supports the Windows platform and the Mac platform but does not support the Android platform, the iOS platform and the Black Berry platform used by the free transmitting end application 120. In another example, the C application supports Mac platform and iOS platform used by the free transmitting end application 120, but does not support the Windows platform, the Android platform and the Black Berry platform. An internal flag of the receiving end application 20 is configured to define which platforms to support, but is not limited thereto. It should be noted that, the above mentioned determining mechanism of the platforms supported can also be executed by a receiving end application 20 or executed by a receiving end application 10, and is not limited thereto. As mentioned above, the receiving end application 20 can be an embedded receiving end application 230. For example, an embedded receiving end application 230 is installed in a smart television during manufacturing process in the factories. Television manufactures sign contracts with application developers according to marketing strategies and decide which embedded receiving end application 230 is installed with which smart television. In addition, a transmitting end application 10 can be an embedded transmitting end application 130 and an embedded transmitting end application 130 can be installed in the smart TV or the tablet mentioned above by default in factories, and is not limited thereto. In the example of using the embedded receiving end application 230, the television manufacturers pay reasonable royalties upon signing contracts. Application developers configure the embedded receiving end application 230 for supporting all platforms used by the free transmitting end application 120. As the D application shown in Table A, consumers purchase smart televisions and are allowed to establish an unlimited connection by the transmitting end apparatus 1 using any platform and perform screen mirroring for displaying the screen image on the smart televisions. On the other hand, if the manufacturers do not pay royalties, the application developers do not configure the embedded receiving end application 230 to support any platform used by the free transmitting end application 120. As the E application shown in Table A, consumers purchase the smart televisions and are required to purchase and install a paid transmitting end application 110 in the transmitting end apparatus 1 so as to establish an unlimited connection with smart televisions.

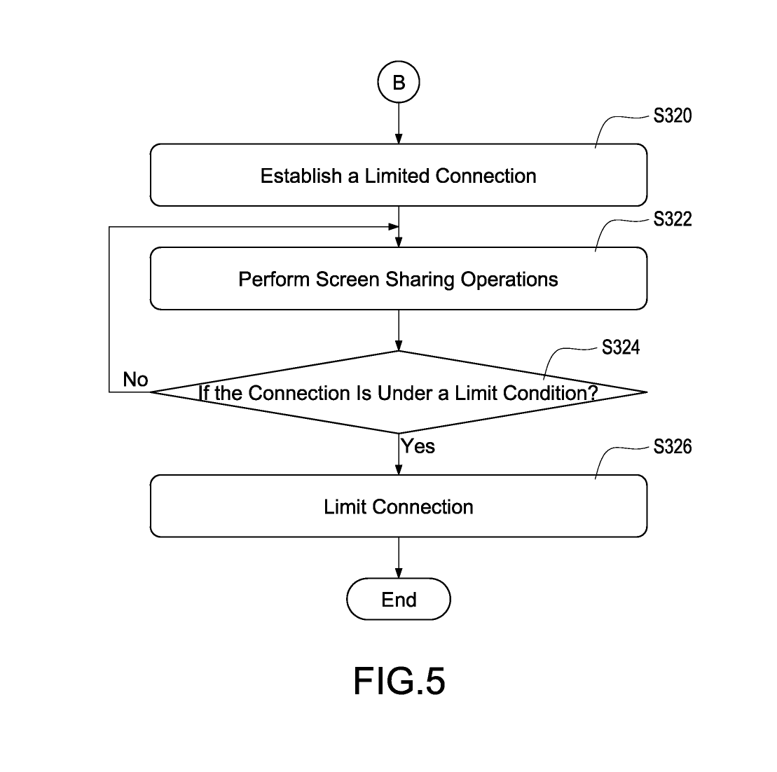

Similarly, if the above mentioned smart TV is installed with the embedded transmitting end application 130 (the D application mentioned above) as the free receiving end application 220 supporting all platforms, the consumers buy the smart TVs and are allowed to sharing the television screen image on the receiving end apparatus 2 of any platforms. On the other hand, if the above mentioned smart TV is installed with the embedded transmitting end application 130 (the E application mentioned above) as a free receiving end application 220 not supporting any platforms, the consumers have to buy and install the paid receiving end application 210 in the receiving end apparatus 2, and then are allowed to receive and display the television screen image shared from the smart TV. FIG. 3A, FIG. 3B and FIG. 5 are a first flow chart, a second flow chart and a third flow chart of a preferred embodiment according to the present invention. Firstly, a request for establishing a connection is made by the transmitting end apparatus 1 or the receiving end apparatus 2 (step S300). The connection request can be made by the transmitting end apparatus 1 or the receiving end apparatus 2, and is not limited thereto. Next, determining if the transmitting end application 10 installed in the transmitting end apparatus 1 is a paid version (step 302). If the transmitting end apparatus 1 is installed with the paid transmitting end application 110, the transmitting end apparatus 1 establishes an unlimited connection directly with the receiving end apparatus 2 (step S304). And the transmitting end apparatus 1 and the receiving end apparatus 2 are allowed to perform screen mirroring operations after the connection is established successfully (step S306).

As shown in FIG. 3, if the transmitting end apparatus 1 is installed with the free transmitting end application 120, the free transmitting end application 120 determines the version of the receiving end application 20 installed in the receiving end apparatus 2 (step S308).

After S308, the free transmitting end application 110 judge if the receiving end application 20 is a paid version (step S310). If the receiving end application 20 is a paid version, i.e. the paid receiving end application 210, the free transmitting end application 120 further reads the internal flag in the paid receiving end application 210 (step S312). The flag is used for judging if the paid receiving end application 210 supports the platform used by the free transmitting end application 120 (step S314). If the paid receiving end application 210 supports the platform used by the free transmitting end application 120, an unlimited connection is established between the transmitting end apparatus 1 and the receiving end apparatus 2 (step S316), and screen mirroring is performed after a connection is successfully established (step S318).

However, the step S310 moves to judge if the receiving end application 20 is a free version, or the receiving end application 20 is a paid version. When the step S314 judges the paid receiving end application 210 does not support the platform used by the free transmitting end application 120, and the method moves to steps Shown in FIG. 5.

According to the mentioned above status, a limited connection is established between the transmitting end apparatus 1 and the receiving end apparatus 2 (step S320), and the screen mirroring is performed after a connection is successfully established, (step S322). A limited connection is established between the transmitting end apparatus 1 and the receiving end apparatus 2. Consequently, the free transmitting end application 120 has to judge if the connection is under a limit condition (step S324). For example, the limit condition is a limit of the connection time. When the connection time is up to 5 minutes, the limit condition occurs. The above description is provided as an example and the scope is not limited thereto.

If the connection is not under the limit condition, the transmitting end apparatus 1 and the receiving end apparatus 2 continues to perform screen mirroring. When the connection is under the limit condition, the connection between the apparatus 1 and apparatus 2 is limited (step S326). For example, the connection is forcibly disconnected between the transmitting end apparatus 1 and the receiving end apparatus 2, or a charge reminder message is displayed on the screen of the transmitting end apparatus 1 and/or the receiving end apparatus 2 for reminding users to purchase a paid version application etc., but the scope of the invention is not limited thereto.

It should be noted that, the above steps are used for assuring at least either the transmitting end apparatus 1 or the receiving end apparatus 2 is an application of paid version. Accordingly, given the transmitting end apparatus 1 or the receiving end apparatus 2 uses the Windows platform, users are not required to provide registration code or perform authorization procedure online when installs an application. Thus, the installing process is made convenient to users.

In the embodiment of FIGS. 3A and 3B, the transmitting end application 10 executes the determining mechanism for establishing a connection, such as determining if the transmitting end application 10 is a paid version, determining if the receiving end application 20 is a paid version, and if the receiving end application 20 supports the platform used by the transmitting end application 10. However, it should be noted that the above determining mechanism can be executed by the receiving end application 20 in another embodiment.

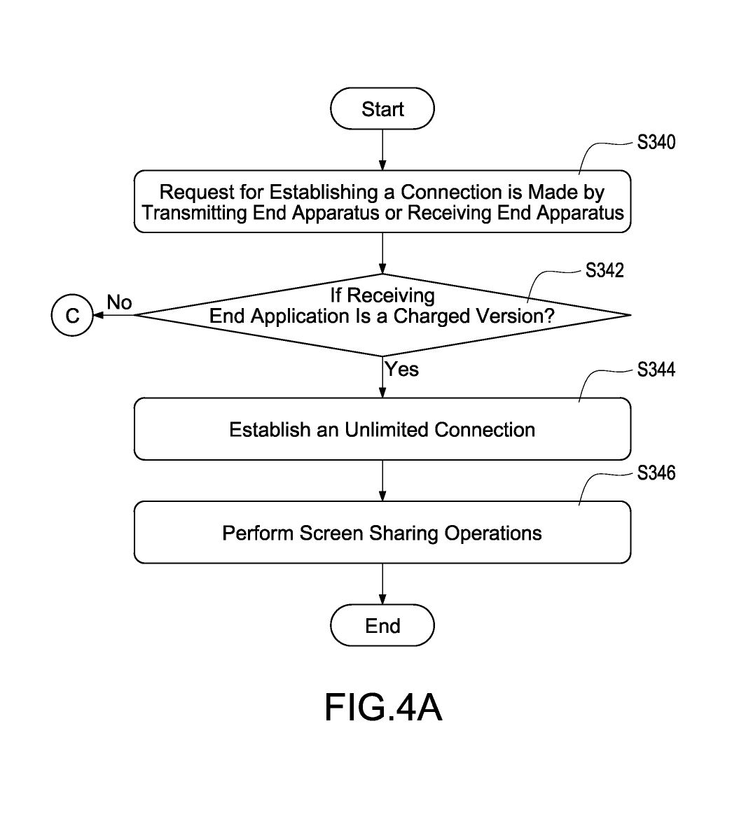

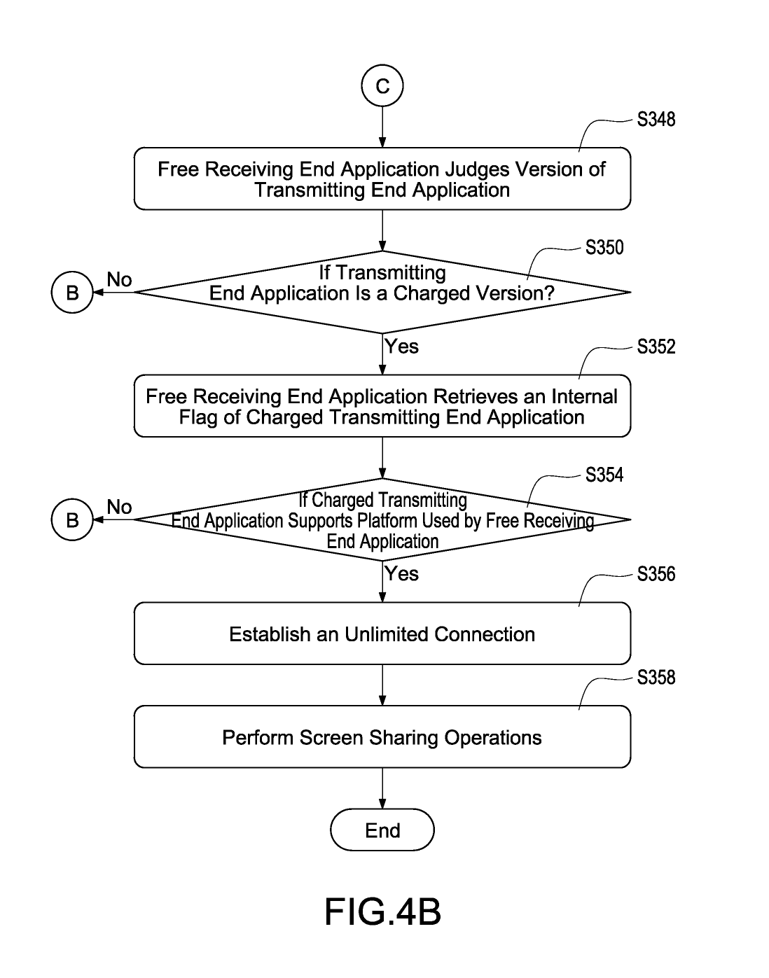

FIGS. 4A and 4B are the first flow chart and the second flow chart of another preferred embodiment according to the present invention. Firstly, a request for establishing a connection is made by the transmitting end apparatus 1 or the receiving end apparatus 2 (step S340). Next, determining if the receiving end application 20 installed in the receiving end apparatus 2 is a paid version (by the receiving end application 20) (step S342). As mentioned in the above embodiment, if the paid receiving end application 210 is installed in the receiving end apparatus 2, the receiving end apparatus 2 directly establish an unlimited connection with the transmitting end apparatus 1 (step S344) and perform screen mirroring operations after the connection is established (step S346).

In the step S342, if the receiving end application 20 is determined as the free receiving end application 220, as shown in FIG. 4B, the free receiving end application 220 further judges the version of the transmitting end application 10 installed in the transmitting end apparatus 1 (step S348). The free receiving end application 220 determines if the transmitting end application 10 is a paid version (step S350). If the transmitting end application 10 is a paid version, then the free receiving end application 220 further retrieve an internal flag in the paid transmitting end application 110 (step S352), wherein the content of the flag is used for determining if the paid transmitting end application 110 supports the platform used by the free receiving end application 220 (step S354). If the paid transmitting end application 110 supports the platform used by the free receiving end application 220, the receiving end apparatus 2 and the transmitting end apparatus 1 establish an unlimited connection (step S356) and perform screen mirroring operations after the connection is established (step S358).

However, in the step S350, if the transmitting end application 10 is determined as a free version or the transmitting end application 10 is determined as a paid version, but the paid transmitting end application 110 is determined not supporting the platform used by the free receiving end application 220 in the step S354, the flow moves back to the step shown in the FIG. 5 as illustrated in the previous embodiment and is not elaborated hereto.

Is should be noted that many integrated applications are popular in recent years and such integrated applications integrate functions of more than one applications. Users only buy one application and execute multiple functions. For example, the screen mirroring function of the present invention is integrated with document processing applications, such as the Office viewer, the PDF viewer etc. Users install the screen mirroring application in the transmitting end apparatus 1, and use the screen mirroring application to transfer the designated documents in the transmitting end apparatus 1, such as content of Office documents or PDF documents to the receiving end apparatus 2 to display.

For example, a “WiFi-Doc” application integrates with the functions of the transmitting end application 10, the Office viewer and the PDF viewer. When the application is installed in the transmitting end apparatus 1 and executed, the transmitting end apparatus 1 is allowed to transfer Office documents or PDF documents in the transmitting end apparatus 1 to the receiving end apparatus 2 and display the Office documents or the PDF documents on the screen of the receiving end apparatus 2 after the connection of the transmitting end apparatus 1 and the receiving end apparatus 2 is established.

In the above mentioned embodiment, before the connection is established, the screen mirroring application determines if the transmitting end application 10/the receiving end application 20 supports the platforms used in the sharing target/sharing source. In the embodiment, before the connection and the sharing, the screen mirroring application also determines if the transmitting end application 10/the receiving end application 20 supports the document content to transfer. For example, a simple screen mirroring application support transferring of any document content, or determining which document content are supported to transfer depending on the pricing. For example, an integrated application integrated with a screen mirroring application and an Office viewer is able to transfer document content of an Office document, and an integrated application integrated with a screen mirroring application and a PDF viewer is able to transfer document content of a PDF document. However, the above mentioned are preferred embodiments of the present invention and the scope of the invention is not limited thereto.

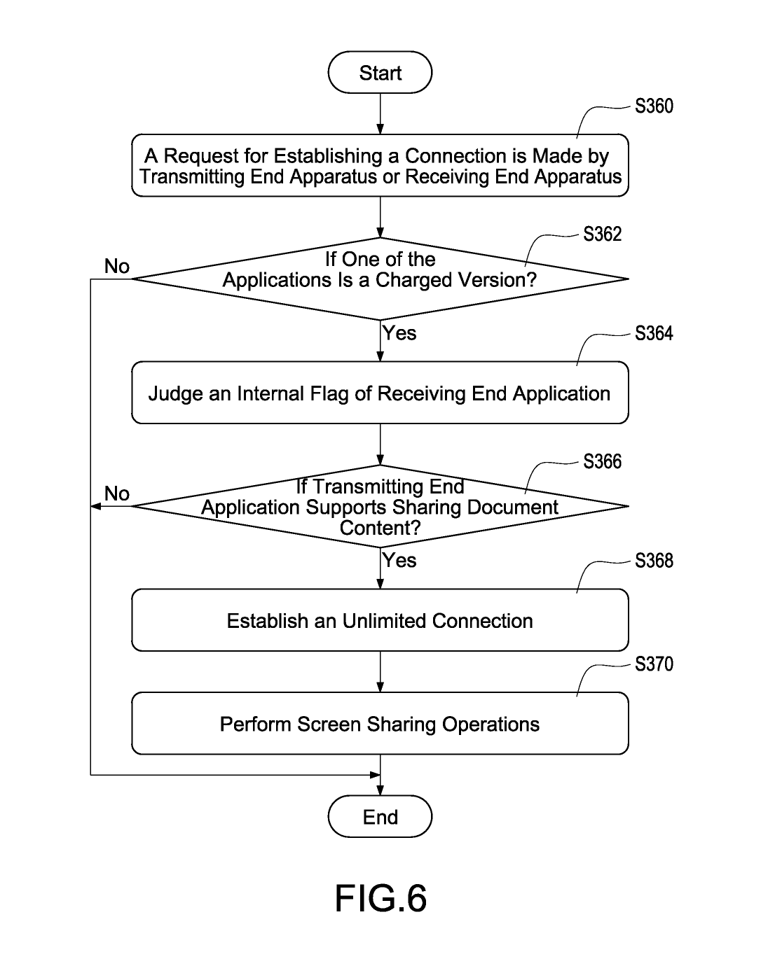

FIG. 6 is the first flow chart of still another embodiment according to the present invention. In the embodiment, the transmitting end application 10 installed in the transmitting end apparatus 1 is integrated with functions in addition to the screen mirroring such as functions of an Office viewer, a PDF viewer or other functions (such as a camera function which is able to transfer photos or films taken by the camera to the receiving end apparatus 2 to display the photos or the films), and are not limited thereto. Firstly, a request for establishing a connection is made by the transmitting end apparatus 1 or the receiving end apparatus 2 (step S360). Next, the transmitting end application 10 determines if one of the transmitting end application 10 and the receiving end application 20 is a paid version via the corresponding step of the above mentioned embodiment (step S362). If the transmitting end application 10 and the receiving end application 20 are both free versions, then the transmitting end apparatus 1 and the receiving end apparatus 2 are not able to establish a connection. Or, establish a limited connection and perform sharing as mentioned in the embodiment shown in the FIG. 5.

If one of the transmitting end application 10 and the receiving end application 20 is a paid version, then the transmitting end application 10 further judges an internal flag of the receiving end application 20 (step S364), wherein the content of the flag is used for determining if the receiving end application 20 supports the document content to transfer from the transmitting end application 10 (step S366). If the receiving end application 20 does not support the document content to transfer from the transmitting end application 10 (for example document content of an Office document or document content of a PDF document), then transmitting end apparatus 1 and the receiving end apparatus 2 are not able to establish a connection; or establish a limited connection and perform sharing as mentioned in the embodiment shown in the FIG. 5. On the other hand, if the receiving end application 20 supports sharing of the document content, then the transmitting end apparatus 1 and the receiving end apparatus 2 establish an unlimited connection (step S368). In addition, perform screen mirroring operations after the connection is established successfully (step S370), wherein the transmitting end application 10 transfers designated document content to the receiving end apparatus 2 and display the designated document content on the screen of the receiving end apparatus 2.

In the embodiment shown in the FIG. 6, the transmitting end application 10 is used for performing the determining mechanism for establishing a connection. However, in another embodiment, the determining mechanism can also be executed by the receiving end application 20.

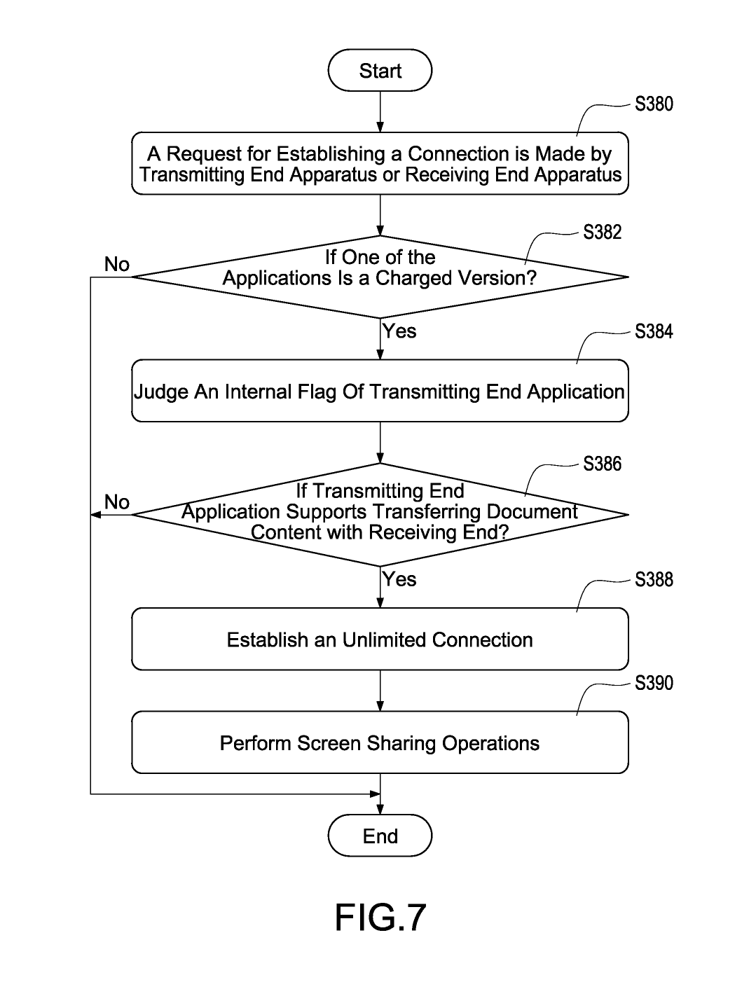

FIG. 7 is a first flow chart of the other preferred embodiment according to the present invention. First, a request for establishing a connection is made by the transmitting end apparatus 1 or the receiving end apparatus 2 (step S380), wherein the step S380 can be executed automatically or manually. In the embodiment, the receiving end application 20 determines if one of the transmitting end application 10 and the receiving end application 20 is a paid version according to the above mentioned step (step S382). If the transmitting end application 10 and the receiving end application 20 are both free versions, then the transmitting end apparatus 1 and the receiving end apparatus 2 are not able to establish a connection or establish a limited connection and perform screen mirroring as shown in the FIG. 5. If one of the transmitting end application 10 and the receiving end application 20 is a paid version, then the receiving end application 20 further judges an internal flag of the transmitting end application 10 (step S384), wherein the content of the flag is used for determining if the transmitting end application 10 supports transferring designated document content to the receiving end application 20 (step S386).

If the transmitting end application 10 is not able to support transferring the designated document content to the receiving end application 20, then the transmitting end apparatus 1 and the receiving end apparatus 2 are not able to establish a connection or establish a limited connection and perform screen mirroring as shown in the embodiment in the FIG. 5. On the other hand, if the transmitting end application 10 supports transferring the designated document content to the receiving end application 20, then the transmitting end apparatus 1 and the receiving end apparatus 2 establish an unlimited connection (step S388). Also, perform screen mirroring operations after the connection is established successfully (step S390), wherein the receiving end application 20 receives the designated document content from the transmitting end application 10, and display the designated document content on the screen of the receiving end apparatus 2.

The characteristic of the present invention is that the determining mechanism of establishing a connection is executed by the transmitting end application 10 or the receiving end application 20 for confirming that the transmitting end apparatus 1 and the receiving end apparatus 2 are able to establish a limited connection, an unlimited connection or are not able to establish a connection before two screen mirroring applications establish a connection. Among which, the determining mechanism comprises but is not limited thereto: 1. whether the transmitting end application 10 is a paid version or a free version; 2. whether the receiving end application 20 is a paid version or a free version; 3. if the transmitting end application 10 supports the platform used by the receiving end application 20; 4. if the receiving end application 20 supports the platform used by the transmitting end application 10; 5. if the receiving end application 20 supports transferring designated document content; and 6. if the transmitting end application 10 supports transferring designated document content to the receiving end application 20. As the skilled person will appreciate, various changes and modifications can be made to the described embodiments. It is intended to include all such variations, modifications and equivalents which fall within the scope of the invention, as defined in the accompanying claims.

What is claimed is:

1. A method of establishing a paid connection using a screen mirroring application between multi-platforms, the method used between a transmitting end apparatus of a sharing source and a receiving end apparatus of a sharing target, the transmitting end apparatus being installed with a transmitting end application, the receiving end apparatus being installed with a receiving end application, the method of establishing a paid connection, comprising:
a) making a request to establish a connection between the transmitting end apparatus and the receiving end apparatus;
b) determining if the transmitting end application is a paid version;
c) if the transmitting end application is a paid version, the transmitting end apparatus and the receiving end apparatus establishing an unlimited connection following step b;
d) the transmitting end apparatus performing screen image sharing via a network system and displaying the shared screen image on the screen of the receiving end apparatus following step c;
e) if the transmitting end application is a free version, judging at the free transmitting end application if the receiving end application is a paid version following step b;
f) establishing an unlimited connection between the transmitting end apparatus and the receiving end apparatus if the receiving end application is a paid version following step e; and
g) the transmitting end apparatus performing screen image sharing via a network system and displaying the shared screen image on the screen of the receiving end apparatus following step f.

2. The method of establishing a paid connection using a screen mirroring application between multi-platforms of claim 1, wherein the method further comprises the following steps:
h) establishing a limited connection between the transmitting end apparatus and the receiving end apparatus if the receiving end application is a free version following steps e;
i) the transmitting end apparatus performing screen image sharing via a network system and displaying the shared screen image on the screen of the receiving end apparatus;
j) determining if the connection between the transmitting end apparatus and the receiving end apparatus is under a limit condition following steps i; and
k) limiting the connection between the transmitting end apparatus and the receiving end apparatus if the connection between the transmitting end apparatus and the receiving end apparatus is under the limit condition.

3. The method of establishing a paid connection using a screen mirroring application between multi-platforms of claim 2, wherein the limit condition is a limit of the connection time.

4. The method of establishing a paid connection using a screen mirroring application between multi-platforms of claim 2, wherein the steps k is forcibly disconnecting the connection between the transmitting end apparatus and the receiving end apparatus.

5. The method of establishing a paid connection using a screen mirroring application between multi-platforms of claim 2, wherein the steps k is displaying a charge reminder message on the screens of the transmitting end apparatus and the receiving end apparatus.

6. A method of establishing a paid connection using a screen mirroring application between multi-platforms, the method used between a transmitting end apparatus of a sharing source and a receiving end apparatus of a sharing target, the transmitting end apparatus being installed with a transmitting end application, the receiving end apparatus being installed with a receiving end application, the method of establishing a paid connection, comprising:
a) making a request to establish a connection between the transmitting end apparatus and the receiving end apparatus;
b) determining if the receiving end application is a paid version;
c) if the receiving end application is a paid version, the transmitting end apparatus and the receiving end apparatus establishing an unlimited connection following step b;
d) the receiving end apparatus receiving the screen image shared by the transmitting end apparatus via a network system and displaying the shared screen image on the screen following step c;
e) if the receiving end application is a free version, the free receiving end application judging if the transmitting end application is a paid version following step b;
f) establishing an unlimited connection between the transmitting end apparatus and the receiving end apparatus if the transmitting end application is a paid version following step e; and
g) the receiving end apparatus receiving the screen image shared by the transmitting end apparatus via a network system and displaying the shared screen image on the screen following step f.

7. The method of establishing a paid connection using a screen mirroring application between multi-platforms of claim 6, wherein the method further comprises the following steps:
h) establishing a limited connection between the transmitting end apparatus and the receiving end apparatus if the transmitting end application is a free version following steps e;
i) the receiving end apparatus receiving the screen image shared by the transmitting end apparatus via a network system and displaying the shared screen image on the screen;
j) determining if the connection between the transmitting end apparatus and the receiving end apparatus is under a limit condition following steps i; and
k) limiting the connection between the transmitting end apparatus and the receiving end apparatus if the connection between the transmitting end apparatus and the receiving end apparatus is under the limit condition.

8. The method of establishing a paid connection using a screen mirroring application between multi-platforms of claim 7, wherein the limit condition is a limit of the connection time.

9. The method of establishing a paid connection using a screen mirroring application between multi-platforms of claim 7, wherein the step k is forcibly disconnecting the connection between the transmitting end apparatus and the receiving end apparatus.

10. The method of establishing a paid connection using a screen mirroring application between multi-platforms of claim 7, wherein the steps k is displaying a charge reminder message on the screens of the transmitting end apparatus and the receiving end apparatus.

11. A method of establishing a paid connection using a screen mirroring application between multi-platforms, the method used between a transmitting end apparatus of a sharing source and a receiving end apparatus of a sharing target, the transmitting end apparatus being installed with a transmitting end application, the receiving end apparatus being installed with a receiving end application, the method of establishing a paid connection, comprising:
a) making a request to establish a connection between the transmitting end apparatus and the receiving end apparatus;
b) determining if one of the transmitting end application and the receiving end application is a paid version;
c) if one of the transmitting end application and the receiving end application is a paid version, further determining if the transmitting end application and the receiving end application are able to transfer designated document content following step b;
d) if the transmitting end application and the receiving end application are able to transfer the designated document content, the transmitting end apparatus and the receiving end apparatus establishing a unlimited connection following step c; and
e) the transmitting end application transferring the designated document content to the receiving end application, and displaying the designated document content on the screen of the receiving end application following step d.

12. The method of establishing a paid connection using a screen mirroring application between multi-platforms of claim 11, wherein the method further comprises a step f: if the transmitting end application and the receiving end application are both free versions, the transmitting end apparatus and the receiving end apparatus are not able to establish a connection following step b.

13. The method of establishing a paid connection using a screen mirroring application between multi-platforms of claim 11, wherein the method further comprises the following steps:
g) if the transmitting end application and the receiving end application are free versions, the transmitting end apparatus and the receiving end apparatus establishing a limited connection following step b;
h) the transmitting end apparatus transferring the designated document content to the receiving end apparatus via a network system, and displaying the designated document content on the screen of the receiving end apparatus;
i) determining if the connection between the transmitting end apparatus and the receiving end apparatus is under a limit condition following step h; and
j) limiting the connection between the transmitting end apparatus and the receiving end apparatus if the connection between the transmitting end apparatus and the receiving end apparatus is under the limit condition.

14. The method of establishing a paid connection using a screen mirroring application between multi-platforms of claim 13, wherein the limiting condition is a limit of the connecting time, and the step i is forcibly disconnecting the connection between the transmitting end apparatus and the receiving end apparatus, or displaying a charge reminder message on the screens of the transmitting end apparatus and the receiving end apparatus.

15. The method of establishing a paid connection using a screen mirroring application between multi-platforms of claim 11, wherein the transmitting end application is integrated with a function of an Office viewer and the designated document content is an Office document.

16. The method of establishing a paid connection using a screen mirroring application between multi-platforms of claim 11, wherein the transmitting end application is integrated with a function of a PDF viewer and the designated document content is a PDF document.

17. The method of establishing a paid connection using a screen mirroring application between multi-platforms of claim 11, wherein the transmitting end application is integrated with a function of camera and the designated document content is a photo or a film.

18. The method of establishing a paid connection using a screen mirroring application between multi-platforms of claim 11, wherein the step c further comprises the following steps:
c1) if one of the transmitting end application and the receiving end application is a paid version, judging an internal flag of the receiving end application following step b; and
c2) determining if the receiving end application supports the designated document content transferred from the transmitting end application according to the content of the flag.

19. The method of establishing a paid connection using a screen mirroring application between multi-platforms of claim 11, wherein the step c further comprises the following steps:
c3) if one of the transmitting end application and the receiving end application is a paid version, judging an internal flag of the transmitting end application following step b; and
c4) determining if the transmitting end application supports transferring the designated document content to the receiving end application according to the content of the flag.
